(19) United States
(12) Patent Application Publication
(10) Pub. No.: US 2024/0400441 A1
(43) Pub. Date: Dec. 5, 2024

(54) METHOD OF MODIFYING A CTE OF AN ULTRA LOW EXPANSION GLASS BODY

(71) Applicant: CORNING INCORPORATED, Corning, NY (US)

(72) Inventors: Michael John Campion, Corning, NY (US); Ying Liu, Kennett Square, PA (US); Johannes Moll, Marco Island, FL (US)

(21) Appl. No.: 18/659,512

(22) Filed: May 9, 2024

Related U.S. Application Data
(60) Provisional application No. 63/505,488, filed on Jun. 1, 2023.

(51) Int. Cl. C03C 23/00; C03C 3/06; C03C 3/078

(52) U.S. Cl. CPC C03C 23/0025; C03C 3/06; C03C 3/078

(57) ABSTRACT

A method of modifying the CTE of a glass body is described, the method including determining a spatial CTE distribution of a ULE glass body including SiO₂ in a range from about 80 wt. % to about 99 wt. % and TiO₂ in a range from about 4 wt. % to about 11 wt. %, the glass body further including at least a first region and a second region, and directing a pulsed laser beam to at least one of the first region or the second region to modify at least one of a first CTE of the first region or a second CTE of the second region.

### CROSS-REFERENCE TO RELATED APPLICATIONS

This application claims the benefit of priority under 35 U.S.C. § 119 of U.S. Provisional Application Ser. No. 63/505,488 filed on Jun. 1, 2023, the content of which is relied upon and incorporated herein by reference in its entirety.

### FIELD

The present disclosure relates to a method of modifying the CTE of a glass body, and in particular the modification of the CTE of an ultra-low expansion glass body.

### BACKGROUND

Ultra-low expansion (ULE) silica-titania glass (e.g., ULE® glass made by Corning Inc.) can be used in various systems, including various mirror systems. For example, ULE glass can be coated with a reflective layer to provide a mirror substrate. The low coefficient of thermal expansion of ULE glass makes it an ideal substrate material for mirrors requiring exacting dimensional stability, for example telescope mirrors. The image quality from telescopes, whether land-based or space-based, depends on the dimensional stability of the mirrors.

Demand for large ULE substrates is also growing for lithography systems used to pattern semiconductor wafers. Extreme ultraviolet (EUV) lithography uses optics to illuminate, project, and reduce pattern images to form integrated circuit patterns. The use of extreme ultraviolet radiation facilitates smaller integrated circuit features. The optics for EUV lithography are currently made from ULE.

In EUV lithography systems, the glass substrate is typically coated with a reflective surface to form a reflective mirror. Furthermore, the glass in an EUV lithography system must meet stringent thermal expansion requirements. Specifically, the glass must maintain its surface shape (known as “figure”) when subjected to temperature changes in the system. A temperature stable glass is necessary to avoid induced distortion in the wavefront characteristics of EUV projection optics.

ULE glass is traditionally made by a flame hydrolysis process in which high purity precursors are injected into flames to form fine glass particles. The fine glass particles can then be shaped into an article by axial pressing, radial pressing, or cold isostatic pressing.

For optical systems requiring ultra-precise ultra-stable components, ultra-low expansion glass is often employed as a materials solution. This glass may be a silica-titania glass with high OH content that can be tuned to exhibit a thermal expansion zero-crossover temperature (T_{ZC}) near room temperature. The expansion properties of this glass are sensitive to titania content, OH content, and fictive temperature.

ULE glass may be produced by the boule growth method. This method grows large cylindrical boules through direct-to-glass deposition from flame hydrolysis of octamethylcyclotetrasiloxane in an array of burners. Because of practical limitations in control of this process, significant inhomogeneities may exist across the boule, leading to areas with higher and lower TiO₂ content. These inhomogeneities lead to changes in expansion behavior across the glass and limit the applicability of ULE material in the most sensitive applications, such as EUV lithography mirrors. Other methods may use flame hydrolysis to produce a loose soot that may later be molded (e.g., pressed) to form a boule or other body.

Much effort is being put into improving materials homogeneity through process development initiatives, which have included soot pressing, use of SiCl and/or TiCl precursors, and adjusting boule making equipment and processes therefor. These approaches all focus on creating completely uniform TiO₂ throughout the glass body (the main driver of non-uniformity). Though strides have been made, none of these approaches have been wholly successful in achieving the desired CTE homogeneity and glass quality.

### SUMMARY

As discussed below, ULE glass produced by various methods may not have uniform consistency. Because thermal expansion properties depend on uniform consistency, a ULE glass body may not exhibit uniform thermal expansion across the glass body. Having a uniform thermal expansion across the glass body allows the glass body to not expand when exposed to different temperature environments, which is beneficial in, for example, lithography applications.

EUV lithography technology relies on an optical projection system to expose a reflective photomask with EUV light such that light reflected from the photomask is directed to a thin photosensitive layer deposited on the surface of a semiconductor wafer. This technique is commonly used in the semiconductor device production process. EUV lithography systems operate at a wavelength of about 13.5 nanometers (nm). This extremely short wavelength poses challenges to the design of EUV systems. For example, reflective coatings on mirror bodies in EUV systems are not able to reflect all the light with such a short wavelength. About thirty percent of incident light is absorbed by the reflective coatings rather than reflected. The absorbed light produces heat in the mirror body, causing the mirror body to change volume (e.g., thermally expand when heated or contract upon cooling). Such changes in the mirror body can in turn cause the reflective coating on the mirror body to deform, which leads to distortions in the wavefront of the reflected light. Wavefront distortion may deteriorate the EUV system resolution and produce errors in patterns formed on the photosensitive layer by the system.

Thus, mirror bodies must be able to maintain their shape and figure even when subjected to the demanding thermal loads of EUV systems. Silica-titania ULE glass is presently the material of choice for mirror bodies in EUV systems.

It has also recently been shown that higher levels of uniformity in the silica-titania glass reduce any expansion or contraction of the glass in an EUV system. More specifically, with such higher levels of uniformity, the glass maintains its overall figure when subject to temperature changes in the EUV system. Methods of achieving CTE uniformity are needed.

However, in other instances, a non-uniform CTE may be desired. For example, certain regions of a ULE glass body may be required to have a first CTE while other regions may be required to have a different CTE. Such divergent CTE's may not be easily achieved with a bulk forming process.

Accordingly, a method of modifying the CTE of a ULE glass body is disclosed.

In a first aspect, a method of modifying a CTE of an ultra-low expansion glass is described, comprising determining a spatial CTE distribution of a glass body comprising SiO₂ in a range from about 80 wt. % to about 99 wt. % and TiO₂ in a range from about 4 wt. % to about 11 wt. %, the glass body comprising at least a first region and a second region, and directing a pulsed laser beam to at least one of the first region or the second region to modify at least one of a first CTE of the first region or a second CTE of the second region.

In a second aspect, prior to the directing of the first aspect, the first CTE is different from the second CTE.

In a third aspect, if the first CTE is less than the second CTE, the directing of the first aspect may comprise directing the pulsed laser beam at the first region of the glass body to increase the first CTE.

In a fourth aspect, if the first CTE is greater than the second CTE, the directing of the first aspect may comprise directing the laser beam at the second region of the glass body to increase the second CTE.

In a fifth aspect, the method of any one of the first aspect to the fourth aspect may further comprise forming the glass body and performing a first anneal of the glass body after the forming. The first anneal may be performed before the directing.

In a sixth aspect, the method of the fifth aspect may further comprise performing a second anneal of the glass body after the first anneal.

In a seventh aspect, the second anneal of the sixth aspect may be performed prior to the directing the pulsed laser beam, but, for example, after performing the first anneal.

In an eighth aspect, the second anneal of the sixth aspect may be performed after the directing the pulsed laser beam.

In a ninth aspect, an average hydroxyl concentration in the glass body of any one of the first aspect to the eighth aspect may be in a range from about 400 ppm to about 1000 ppm.

In a tenth aspect, the laser beam of any one of the first aspect to the ninth aspect may comprise a focus point, the method further comprising producing relative motion between the focus point and the glass body.

In an eleventh aspect, the glass body of the tenth aspect may comprise a glass plate comprising a first major surface, a second major surface opposite the first major surface, and a thickness defined between the first major surface and the second major surface, and the producing relative motion between the focus point and the glass body may comprise varying a position of the focus point along an axis extending through the thickness of the glass body.

In a twelfth aspect, the glass body of the tenth aspect may comprise a glass plate comprising a first major surface, a second major surface opposite the first major surface, and the producing relative motion between the focus point and the glass body may comprise varying a position of the focus point in a plane extending between the first major surface or the second major surface.

In a thirteenth aspect, a pulse repetition rate of the pulsed laser beam of any one of the first aspect to the twelfth aspect may be in a range from about 100 kHz to about 1 GHz.

In a fourteenth aspect, an energy density of the pulsed laser beam of any one of the first aspect to the thirteenth aspect may be in a range from about 0.1 J/mm³ to about 50 J/mm³.

In a fifteenth aspect, a wavelength of the pulsed laser beam of any one of the first aspect to the fourteenth aspect may be in a range from about 780 nm to about 1100 nm.

In a sixteenth aspect, the wavelength of the fifteenth aspect may be in a range from about 1000 nm to about 1100 nm.

In a seventeenth aspect, the modifying the first CTE relative to the second CTE produces a CTE gradient in the glass body of the first aspect.

In an eighteenth aspect, a method of modifying a CTE of an ultra-low expansion glass is disclosed, comprising determining a spatial CTE distribution of a glass body comprising SiO₂ in a range from about 80 wt. % to about 99 wt. % and TiO₂ in a range from about 4 wt. % to about 11 wt. %, the glass body comprising at least a first region having a first CTE and a second region having a second CTE different from the first CTE, directing a pulsed laser beam to at least one of the first region or the second region to modify at least one of the first CTE or the second CTE, and annealing the glass body after the directing the pulsed laser beam.

In a nineteenth aspect, the method of the eighteenth aspect may further comprise producing relative motion between the laser beam and the glass body such that the laser beam traverses a surface of the glass body.

In a twentieth aspect, the laser beam comprises a focus point, the method of the eighteenth aspect to the nineteenth aspect may further comprise varying a position of the focus point within the glass body relative to a surface of the glass body.

In a twenty first aspect, a pulse repetition rate of the pulsed laser beam of any one of the eighteenth aspect to the twentieth aspect may be in a range from about 100 kHz to about 1 GHz.

In a twenty second aspect, an energy density of the pulsed laser beam of any one of the eighteenth aspect to the twenty first aspect may be in a range from about 0.1 J/mm³ to about 50 J/mm³.

In a twenty third aspect, a wavelength of the pulsed laser beam of any one of the eighteenth aspect to the twenty second aspect may be in a range from about 780 nm to about 1100 nm.

In a twenty fourth aspect, the wavelength of the twenty third aspect may be in a range from about 1000 nm to about 1100 nm.

In a twenty fifth aspect, the modifying at least one of the first CTE or second CTE of the eighteenth aspect may comprise increasing the at least one of the first CTE or the second CTE.

In a twenty sixth aspect, a method of modifying a CTE of an ultra-low expansion glass is disclosed, comprising determining a spatial CTE distribution of a glass body comprising SiO₂ in a range from about 80 wt. % to about 99 wt. % and TiO₂ in a range from about 4 wt. % to about 11 wt. %, the glass body comprising at least a first region having a first CTE and a second region having a second CTE less than the first CTE, and directing a pulsed laser beam to the second CTE to increase the second CTE relative to the first CTE.

In a twenty seventh aspect, the method of the twenty sixth aspect may further comprise annealing the glass body after the directing the pulsed laser beam, the annealing reducing an average CTE of the glass body.

In a twenty eighth aspect, the pulsed laser beam of any one of the twenty sixth aspect to the twenty seventh aspect may comprise a focus point, the method further comprising varying a position of the focus point within the glass body relative to a surface of the glass body.

In a twenty ninth aspect, a pulse repetition rate of the pulsed laser beam of any one of the twenty sixth aspect to the twenty eighth aspect may be in a range from about 100 kHz to about 1 GHz.

In a thirtieth aspect, an energy density of the pulsed laser beam of any one of the twenty sixth aspect to the twenty ninth aspect may be in a range from about 0.1 J/mm³ to about 50 J/mm³.

In a thirty first aspect, a wavelength of the pulsed laser beam of any one of the twenty sixth aspect to the thirtieth aspect may be in a range from about 780 nm to about 1100 nm.

In a thirty second aspect, the wavelength of the thirty first aspect may be in a range from about 1000 nm to about 1100 nm.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

FIG. 1 is flow chart depicting an exemplary process for manufacturing a ULE glass body;

FIG. 2 is a schematic view of an apparatus for carrying out the process of FIG. 1;

FIG. 3 is a perspective view of an exemplary ULE glass body;

FIG. 4 is a top view of a sample portion of the ULE glass body of FIG. 3 showing a plurality of segments that may have varying characteristics, e.g., compositions or performance attributes;

FIG. 5 is a top view of another sample portion wherein a plurality of segments are spaced apart from edges of the sample portion;

FIG. 6 is an exemplary plot of hydroxyl content for a hypothetical sample portion of a ULE glass body having varying hydroxyl content across the sample;

FIG. 7 is an exemplary plot of titania concentration for a hypothetical sample portion of a ULE glass body having varying titania concentration;

FIG. 8 is an exemplary plot of average T_{ZC} for a hypothetical sample portion of a ULE glass body having varying T_{ZC};

FIG. 9 is an exemplary plot of refractive index for a hypothetical sample portion of a ULE glass body having a varying refractive index;

FIG. 10 is an exemplary plot of the coefficient of thermal expansion (CTE) for a hypothetical sample portion of a ULE glass body having varying CTE;

FIG. 11 is a schematic view of an apparatus for pulsed laser modification of the CTE of a ULE glass body (e.g., glass substrate);

FIG. 12 comprises a series of schematic views illustrating exemplary modification paths followed by the pulsed laser during laser modification of a ULE glass body;

FIG. 13 comprises several Raman spectra of untreated ULE glass, laser treated ULE glass, and ULE glass that has been overexposed to laser radiation;

FIG. 14 comprises several top view and cross-sectional views of ULE glass after laser treatment, including overlapping, overexposed portions;

FIG. 15 is a plot showing the change in CTE as a function of laser exposure energy density in Joules/millimeter³ (J/mm³);

FIG. 16 is a plot showing the change in zero-crossing temperature (T_{ZC}) as a function of laser exposure energy density in J/mm³;

FIG. 17 is a plot showing CTE slope change as a function of laser exposure energy density in J/mm³;

FIG. 18 is a plot showing CTE of a ULE glass body before and after laser processing as described in herein; and

FIG. 19 is a flow chart of an exemplary process for modifying the CTE of a ULE glass body.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure can be embodied in many different forms and should not be construed as limited to the embodiments set forth herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Ranges can be expressed herein as from “about” one particular value, and/or to “about” another particular value. When such a range is expressed, another embodiment includes from the one particular value to the other particular value. Similarly, when values are expressed as approximations by use of the antecedent “about,” it will be understood that the particular value forms another embodiment. It will be further understood that the endpoints of each of the ranges are significant both in relation to the other endpoint, and independently of the other endpoint.

Directional terms as used herein—for example, up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic with respect to arrangement of steps, operational flow, order of components, or orientation of components; plain meaning derived from grammatical organization or punctuation, and the number or type of embodiments described in the disclosure.

As used herein, the singular forms “a,” “an,” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including,” and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, within about 2% of each other, or within about 1% of each other, depending on context.

For brevity, ranges of values disclosed herein, including compositional ranges or attribute (performance) ranges, or series of ranges, may be appended by the phrase “including all ranges and subranges therebetween,” which is to be interpreted as including whole number or decimal subranges as though explicitly presented. Thus, by way of example, a range between 6 and 8 (units omitted) implicitly includes a subrange between 6.4 and 8, or a subrange between 6 and 7.2, or a subrange between 6 and 7, etc. Additionally, a series of ranges, such as “in a range from 6 to 11 or in a range from 6 to 9” implicitly includes a range from 7 to 10, or subranges therebetween, such as 7.2 to 10.4, as though explicitly presented, provided the range does not exceed the minimum or maximum endpoints of the explicitly presented range or ranges.

The term “ULE” stands for “ultra-low expansion,” which is a reference to an ultra-low coefficient of thermal expansion (CTE). For purposes of this disclosure, an ultra-low coefficient of thermal expansion is a coefficient of thermal expansion between about −30 ppb/K (−30×10⁻⁹/K) and 30 ppb/K (30×10⁻⁹/K) at each temperature in a range from 5° C. to 35° C. As used herein, “ppb” refers to parts per billion in weight, and K represents temperature in Kelvin. The term “ULE glass body,” “ULE glass substrate,” or “ULE glass” refers to silica-titania glass having an ultra-low coefficient of thermal expansion. A silica-titania glass is a glass that includes silica (SiO₂) and titania (TiO₂). In some embodiments, the silica concentration may be equal to or greater than about 80 wt. %, equal to or greater than about 85 wt. %, equal to or greater than about 90 wt. %, equal to or greater than about 92 wt. %, equal to or greater than about 95 wt. %, equal to or greater than about 97 wt. %, equal to or greater than about 98 wt. %, or equal to or greater than about 99 wt. %. For example, the silica concentration may be in a range from about 80 wt. % to about 99 wt. %, in a range from about 82 wt. % to about 97 wt. %, in a range from about 84 wt. % to about 95 wt. %, or in a range from about 86 wt. % to about 92 wt. %, including all ranges and subranges therebetween.

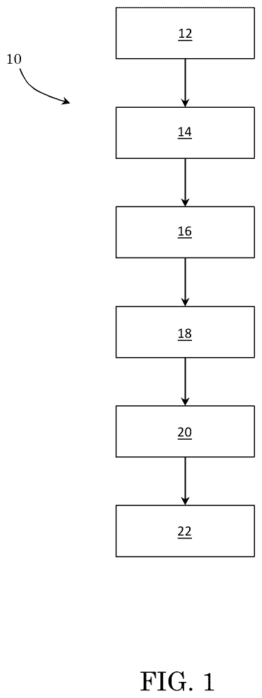

FIG. 1 depicts a flowchart for an exemplary process 10 to form a ULE glass body, for example a ULE glass substrate. The ULE glass body may be prepared, beginning at step 12, by flame hydrolyzing a mixture of a silica precursor and a titanium precursor to form loose soot particles, each soot particle comprising SiO₂ and TiO₂.

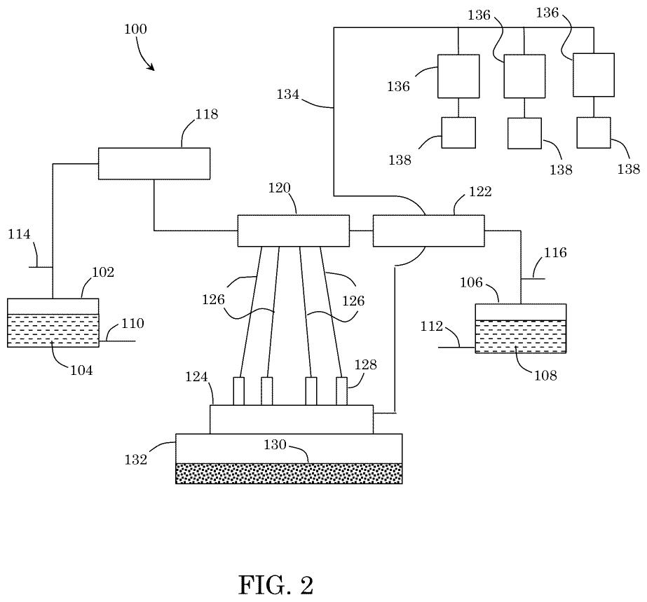

FIG. 2 depicts a schematic representation of an exemplary system 100 for producing loose soot particles by a flame hydrolysis process. System 100 comprises a first reservoir 102 containing silica precursor 104 and a second reservoir 106 containing titania precursor 108. Temperatures of first and second reservoirs 102, 106 may be monitored and regulated such that precursor temperatures within each reservoir are uniform and constant (e.g., within +/−0.5° C.) throughout the respective precursor. First reservoir 102 includes an inlet 110 for introducing a first carrier gas, such as nitrogen, for example at or near the base of the first reservoir. The carrier gas forms a vaporous stream with the silica precursor 104. Similarly, second reservoir 106 includes an inlet 112 for introducing a second carrier gas, such as nitrogen, for example at or near the base of the second reservoir. The carrier gas in second reservoir 106 forms a vaporous stream with the titania precursor 108. The first and second carrier gases may be flowed through inlets 110, 112 and into respective reservoirs 102, 106 at a consistent flow rate to avoid introduction of flow perturbations into system 100. More specifically, the first and second carrier gases flowing into inlets 110, 112 may be flowed at a flow rate within 5% of each other. The silica precursor 104 may comprise, for example, octamethylcyclotetrasiloxane, and the titania precursor 108 may comprise, for example, titanium tetraisopropoxide. Other precursor materials as are known in the art may be used.

Bypass streams of carrier gas may also be introduced into system 100 at inlets 114 and 116 to prevent saturation of the vaporous silica stream and the vaporous titania stream. In embodiments, the vaporous silica stream and the vaporous titania stream may be heated, for example by hot oil tracing to prevent hot and cold spots within the streams. Both hot and cold spots within a vaporous stream may affect precursor concentrations in the stream, thus producing glass with suboptimal properties. The vaporous silica stream passes through distribution system 118 to manifold 120, and the vaporous titania stream passes through distribution system 122 to manifold 120.

The silica and titania vaporous streams may be mixed in manifold 120 to form a mixture of the two vaporous streams. As further shown in FIG. 2, the mixture of the two vaporous streams flows to furnace 124. More specifically, the mixture of the two vaporous streams passes through fume lines 126 to burners 128 mounted in an upper portion of furnace 124. While not shown, the two vaporous streams may be further joined with a fuel (e.g., natural gas, hydrogen, etc.) and oxygen mixture at burners 128. Introduction and subsequent hydrolyzation of the two vaporous streams in the fuel-oxygen flame at burners 128 forms loose soot particles 130. As used herein, the term “soot” refers to fine glass particles formed by the flame hydrolysis process. The fuel and oxygen mixture may be combined with the silica and titania vaporous streams at burners 128 such that the amount of oxygen is at least in a 1:1 ratio with the amount of silica and titania vapor combined (including any carrier gases). Therefore, the amount of oxygen may at least equal the amount of silica and titania vapor (including any carrier gases), or 2×, or 3×, or 4×, etc. the amount of silica and titania vapor (including any carrier gases).

At step 14 of process 10, the loose soot particles 130 are cooled and directed to a collection chamber. In some embodiments, the loose soot particles 130 may be directed into collection chamber 132. In other embodiments, the loose soot particles 130 may be directed vertically upward through a tube 134 rather than downward into collection chamber 132. Tube 134 may be a quartz tube that carries soot particles 130 in a stream to one or more filter bags 136. The soot particles 130 may be removed from the stream by the filter bags 136 and deposited into one or more collection chambers 138. For example, soot particles 130 may fall from filter bags 136 into collection chambers 138. A pulse of gas, for example nitrogen gas, may periodically be applied to filter bags 136 to prevent excess accumulation of soot particles 130 on the bags. In some embodiments, collection chambers 138 may be stainless steel hoppers. Soot particles 130 may be collected from collection chambers 138 and deposited into barrels, where soot particles 130 may be stored until needed.

At step 16 of process 10, soot particles 130 may be transported from the barrels to a mold to form a molded precursor body. The mold may be graphite with a very high cleanliness level (e.g., an impurity level of less than 100 ppm). As used herein, “ppm” refers to parts per million by weight. Soot particles 130 may be pressed in the mold by a pressing apparatus to form a molded intermediate body, which may then be heat treated in the presence of steam or under vacuum pressure (e.g., at a pressure less than about 1 torr) to form a consolidated molded intermediate body. The consolidated molded intermediate body is opaque following the heat treatment step.

In embodiments in which the molded intermediate body is heat treated under vacuum pressure, the molded intermediate body is not doped with hydroxyl during step 16 of process 10. Therefore, such embodiments may be referred to as “no OH doping.” In contrast, when heating the molded intermediate body in the presence of steam (also referred to as “steam doping,” as discussed further below), the body is doped with hydroxyl. The “no OH doping” process produces a glass body with a reduced hydroxyl concentration compared to the steam doping process.

In yet other embodiments, the molded intermediate body may be actively dried during the heat treatment step to form a consolidated molded intermediate body. During such active drying, the molded intermediate body may be exposed to a drying agent while heating the molded intermediate body in a furnace. For example, the drying agent may be a halide, such as chloring and/or fluorine, or carbon monoxide. Actively drying the molded intermediate body leads to a reduced concentration of hydroxyl in the resultant body, even less when compared with the “no OH doping process.”

In the “no OH doping” and steam doping processes, the molded intermediate body may not be exposed to a halide agent. Therefore, in these embodiments, the final glass body may not comprise a halide such that the final glass body is halide-free (e.g., may comprise less than 100 ppm of a halide).

Furthermore, during the consolidation heating of step 16, the molded intermediate body may be heated in a furnace at a heating rate of about 2.5° C./hour or less.

Step 18 of process 10 comprises melting the consolidated molded precursor body into a melt, flowing the melt into another mold, and then cooling the melt to form a glass. Once the glass is cooled, it forms a glass body. This glass body no longer has the opaqueness that was produced during the consolidation of step 16.

At step 20, the glass body is exposed to an environment having an elevated temperature and an elevated pressure for a time. In some embodiments, the environment having the elevated temperature and the elevated pressure may comprise an inert gas. By “inert gas,” what is meant is a gas that does not chemically react with the glass body. In some embodiments, the elevated pressure may be in a range from about 3.5E6 Pascal (0.5 kpsi) to about 1.03E8 Pascal (15 kpsi). Furthermore, in some embodiments, the elevated temperature may be in a range from about 1000° C. to about 1800° C. The glass body may be subjected to the environment for a time in a range from about 1 hour to about 120 hours. The step 20 of subjecting the glass body to an environment having elevated pressure and elevated temperature can be referred to as “hot isostatic pressing.”

Step 22 of process 10 comprises an annealing step. During this step, internal stresses within the glass body from the forming process are relaxed, which provides better quality cutting and machining of the glass body. In addition, step 22 of annealing the glass body lowers the average zero crossing temperature Tzc of the substrate, which will be discussed in more detail further below.

As discussed above, in embodiments, glass bodies of the present disclosure are comprised of titania-silica glass that may comprise a high concentration of hydroxyl groups, which can be achieved by consolidating the molded intermediate glass body (e.g., during step 16 of process 10) in a steam-containing atmosphere.

Processing the molded intermediate glass body using a steam doping process may include thermal treatment in a steam-free atmosphere, exposing the thermally treated intermediate glass body to steam, and consolidation of the thermally treated intermediate glass body in a steam-containing atmosphere.

Thermal treatment of an intermediate glass body in a steam-free atmosphere enables purging and removal of gases from the intermediate glass body. The thermal treatment process may occur in a steam-free atmosphere at a temperature in a range from about 100° C. to about 900° C., in a range from about 200° C. to about 700° C., or in a range from about 300° C. to about 600° C. The steam-free atmosphere may further include an inert gas. Furthermore, the thermal treatment may occur for a time sufficient to increase an internal temperature of the intermediate glass body to at least 100° C., at least 200° C., or in a range from about 100° C. to about 600° C., in a range from about 100° C. to about 500° C., or in a range from about 150° C. to about 600° C., including all ranges and subranges therebetween.

After thermal treatment in the steam-free atmosphere, the intermediate glass body may then be exposed to a steam-containing atmosphere to load the intermediate glass body with hydroxyl groups. The steam-containing atmosphere may include steam, or steam in combination with an inert gas. The pressure of the steam-containing atmosphere may be in a range from about 1.01E4 Pascal (e.g., 0.1 atmosphere) to about 1.01E6 Pascal (10 atmosphere), or in a range from about 5.07E4 Pascal (0.5 atmosphere) to about 5.07E5 Pascal (5 atmosphere). The pressure of the steam-containing atmosphere should be constant within the furnace, with any pressure difference being +/−2% of the absolute pressure in the furnace. The temperature at which the intermediate glass body is exposed to the steam-containing atmosphere may be in a range from about 200° C. to about 900° C., such as in a range from about 300° C. to about 700° C. The temperature at which the intermediate glass body is exposed to the steam-containing atmosphere may be less than a temperature that induces densification or consolidation of the body. The time of exposure of the intermediate glass body to the steam-containing atmosphere can be adjusted to control the concentration of hydroxyl groups incorporated into the intermediate glass body. Longer exposure times lead to higher concentrations of hydroxyl.

After exposure of the intermediate glass body to the steam-containing atmosphere, the intermediate glass body may be consolidated in the presence of steam. The steam-containing consolidation atmosphere may have the same composition as the steam-containing loading atmosphere (as described above). Consolidation of the intermediate glass body in the steam-containing consolidation atmosphere may occur at a temperature (consolidation temperature) and for a time sufficient to transform the intermediate glass body from a porous body to a body having closed pores. The consolidation temperature may be in a range from about 900° C. to about 1850° C., in a range from about 900° C. to about 1700° C., in a range from about 900° C. to about 1500° C., or in a range from about 900° C. to about 1300° C. The time of exposure of the body to the steam-containing consolidation atmosphere may be at least about 0.5 hours, for example at least about 1 hour, at least about 2 hours, or at least about 5 hours. The heating rate may be in a range from about 3° C./min to about 100° C./min, or in a range from about 5° C./min to about 50° C./min. The steam consolidation step may include holding the intermediate glass body at a fixed temperature (a holding temperature) for a pre-determined time. The holding temperature may be in a range from about 1000° C. to about 1250° C., or in a range from about 1150° C. to about 1200° C., such that the temperature is increased at a heating rate of about 2.5° C./hour or higher. A peak holding temperature during the steam consolidation step may be about 1250° C. The intermediate glass body may be held at the holding temperature for a time in a range from about 1 hour to about 240 hours, or in a range from about 5 hours to about 20 hours to convert the molded intermediate glass body to a consolidated ULE glass body.

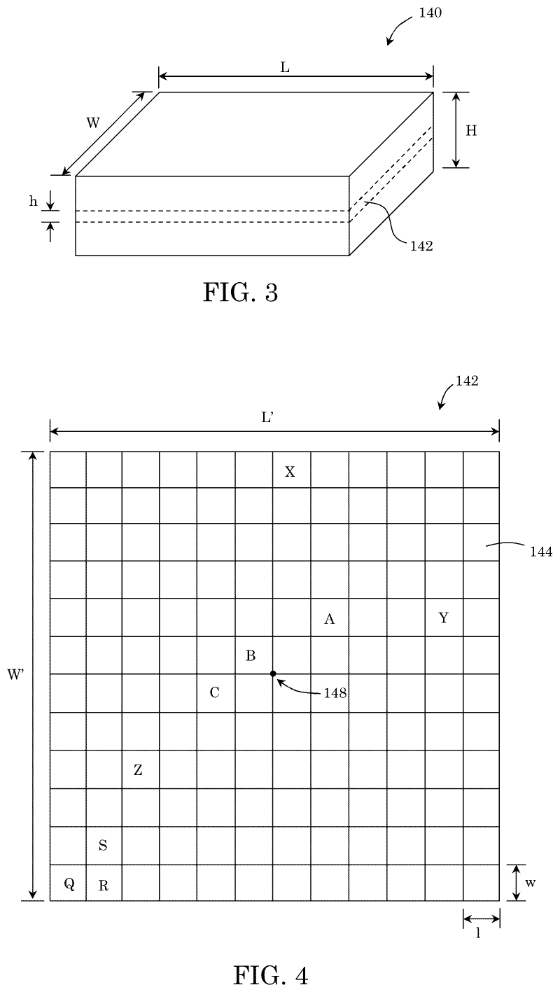

FIG. 3 shows an exemplary ULE glass body 140, e.g., a glass substrate, having a length (L), a width W, and a height H, which may be formed by the above process or other processes for producing ULE glass bodies. In some embodiments, each of the length L and the width W may be greater than the height H. For example, the length L and the width W may each be about 500 millimeters (mm) or less, about 450 mm or less, about 400 mm or less, about 350 mm or less, about 300 mm or less, about 250 mm or less, about 200 mm or less, about 150 mm or less, about 100 mm or less, about 75 mm or less, about 50 mm or less, about 25 mm or less, about 20 mm or less, or about 15 mm or less. Additionally or alternatively the length L and width W of glass body 140 may each be about 15 mm or greater, or about 20 mm or greater, or about 25 mm or greater, or about 50 mm or greater, or about 75 mm or greater, or about 100 mm or greater, or about 150 mm or greater, or about 200 mm or greater, or about 250 mm or greater, or about 300 mm or greater, or about 350 mm or greater, or about 400 mm or greater, or about 450 mm or greater, or about 500 mm or greater. In some embodiments, both the length L and the width W may be about 150 mm, or about 152 mm, or about 179 mm. However, it is also contemplated that the length L can be different from the width W in some embodiments.

In some embodiments, the height H of ULE glass body 140 may be about 400 mm or less, about 350 mm or less, about 300 mm or less, about 250 mm or less, about 200 mm or less, about 150 mm or less, about 100 mm or less, about 75 mm or less, about 50 mm or less, about 25 mm or less, about 20 mm or less, about 15 mm or less, about 10 mm or less, or about 5 mm or less. Additionally or alternatively, the height H of ULE glass body 140 may be about 5 mm or greater, about 10 mm or greater, about 15 mm or greater, about 20 mm or greater, about 25 mm or greater, about 50 mm or greater, about 75 mm or greater, about 100 mm or greater, about 150 mm or greater, about 200 mm or greater, about 250 mm or greater, about 300 mm or greater, about 350 mm or greater, or about 400 mm or greater. In some embodiments, the height H of ULE glass body 140 may be about 63 mm, about 150 mm, or about 152 mm.

ULE glass body 140 may comprise a titania-doped silica glass. In embodiments, ULE glass body 140 may be produced by precursors comprised of, for example, octamethylcyclotetrasiloxane and titanium tetraisopropoxide. It is also contemplated that glass body 140 may comprise one or more additional glass modifiers and/or additives.

The silicon dioxide (SiO₂) concentration in ULE glass body 140 may be about 80 wt. % or more, about 85 wt. % or more, about 90 wt. % or more, about 92 wt. % or more, about 95 wt. % or more, about 97 wt. % or more, about 98 wt. % or more, about 99 wt. % or more, such as in a range from about 85 wt. % to about 97 wt. %, or in a range from about 90 wt. % to about 95 wt. %.

As discussed above and with reference to FIGS. 3 and 4, ULE glass body 140 may comprise at least one sample 142 comprising a length L′ and a width W′ that may form a sub-portion of ULE glass body 140. In the embodiment of FIGS. 3 and 4, sample 142 may be a cross-sectional sub-portion of ULE glass body 140 such that the height h of sample 142 extends along the height H of ULE glass body 140. The height H of glass body 140 may be less than its width W and length L so that sample 142 forms the cross-sectional sub-portion along the smallest dimension of ULE glass body 140 (e.g., along height H). In the embodiment of FIGS. 3 and 4, ULE glass body 140 may comprise multiple samples 142 along its height H. However, in other embodiments, sample 142 may extend the entire height H of glass body 140. In these embodiments, ULE glass body 140 comprises one sample 142 such that the one sample 142 forms the entire ULE glass body 140.

Although FIGS. 3 and 4 depict ULE glass body 140 and sample 142 as being rectangular components with flat surfaces, ULE glass body 140 and/or sample 142 may comprise other shapes. For example, the outer profile of ULE glass body 140 and/or sample 142 can be circular, elliptical, or a non-symmetrical shape. Furthermore, ULE glass body 140 and/or sample 142 can comprise curved surfaces, forming a concave or convex structure. In one exemplary embodiment, ULE glass body 140 may be formed of a single sample 142 such that the single sample 142 extends for the entire length L, width W, and height H of ULE glass body 140. That is, wherein L′=L, W′=W, and h=H. Sample 142 may be a reticle, a photomask, a mirror, and/or a reticle or photomask holder.

Each sample 142 may have a substantially uniform hydroxyl (OH) and titania (TiO₂) concentration across the length L′ and width W′ of the sample. To determine the uniformity of the samples in a substrate, each sample 142 may be divided into segments across the length and width of the sample. For example, FIG. 4 shows sample 142 divided into a plurality of segments 144 across the cross-sectional length L′ and width W′ of sample 142. The concentration of one or more components (e.g., hydroxyl, titania, silica) may then be determined for each segment 144 to determine the uniformity of each component along sample 142. For example, the concentration of hydroxyl may be measured for each segment 144 to determine the hydroxyl concentration uniformity across the cross-section of sample 142. Furthermore, the concentration of titania may be determined for each segment 144 to determine the titania concentration uniformity across the cross-section of sample 142. As discussed further below, the concentration of the one or more components may be determined through the full thickness (e.g., height) h of each segment 144 of sample 142.

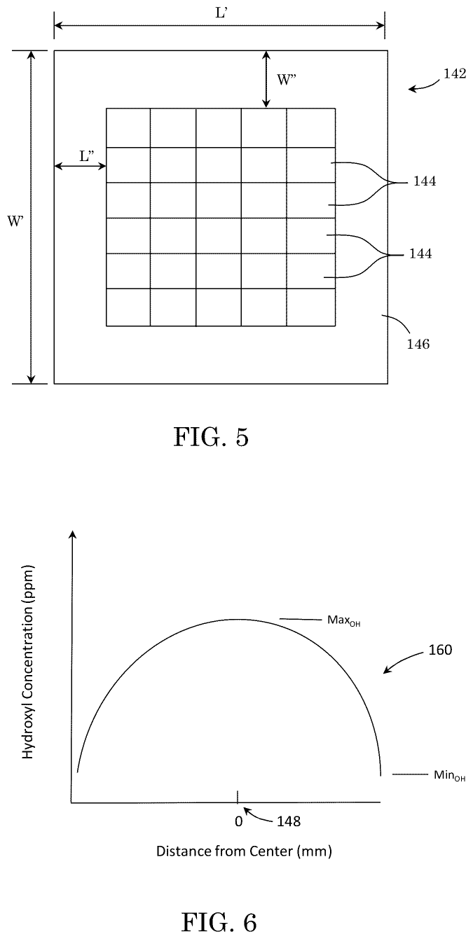

Although FIG. 4 shows segments 144 as extending along the entire length L′ and width W′ of sample 142 (e.g., ULE glass body 140), the portion of sample 142 that comprises segments 144 may be less than the entire cross-sectional length L′ and width W′. For example, as shown in FIG. 5, sample 142 may comprise an outer, peripheral skirt 146 on which segments 144 are not formed. Therefore, outer, peripheral skirt 146 may be a clearance between the end (edge) of segments 144 and the outer edge of sample 142. In embodiments, the outer, peripheral skirt 146 may extend for a length L″ in a range from about 2 mm to about 20 mm, in a range from about 4 mm to about 16 mm, in a range from about 5 mm to about 16 mm, in a range from about 8 mm to about 14 mm, or in a range from about 10 mm to about 12 mm. In some embodiments, the length L″ may be about 12.5 mm or about 12.7 mm. Similarly, outer, peripheral skirt 146 may extend for a width W″ in a range from about 2 mm to about 20 mm, in a range from about 4 mm to about 16 mm, in a range from about 5 mm to about 16 mm, in a range from about 8 mm to about 14 mm, or in a range from about 10 mm to about 12 mm, including all ranges and subranges therebetween. In some embodiments, the width W″ may be about 12.5 mm or about 12.7 mm. Length L″ need not be equal to width W.″ That is, in some embodiments, length L″ may be equal to W″, while in other embodiments, L″ may be less than or greater than W.″

Segments 144 may be adjacent segments across a specific length and width of sample 142. As discussed above, this specific length and width may be equal to or less than the length L′ and width W′ of sample 142. For example, segments 144 may be adjacent segments across a length L′ and width W′ of sample 142 such that the length l and width w of segments 144 are each about 25 mm or greater, about 30 mm or greater, about 40 mm or greater, about 50 mm or greater, about 60 mm or greater, about 75 mm or greater, about 100 mm or greater, about 125 mm or greater, about 150 mm or greater, about 175 mm or greater, about 180 mm or greater, about 190 mm or greater, about 200 mm or greater, or about 250 mm or greater.

When sample 142 comprises flat planar surfaces, segments 144 may be formed along the flat planar surface, as shown in FIG. 4. However, when sample 142 comprises a concave or convex surface, segments 144 may be formed along the curving surface of sample 142.

As shown in FIG. 4, each segment 144 has a length l and a width w that are equal, for example about 12.7 mm each. However, in other embodiments length l may not equal width w. In some embodiments, length l and width w of segments 144 may be equal to the length L″ and/or width W″ of peripheral skirt 146. The height of each segment 144 may be the height h of sample 142.

As discussed above, the concentration of one or more components of ULE glass body 140 may be determined within each segment 144. Therefore, for example, the concentration of hydroxyl, the concentration of titania, and/or the concentration of silica may be determined for each adjacent segment 144 within sample 142. For example, if each segment 144 has a length l and width w of 12.7 mm, the concentration of the components may be determined at a frequency across the cross-section of sample 142. For example, the concentration of hydroxyl may be measured at a spatial frequency of 12.7 mm across the cross-section of sample 142.

The concentration of hydroxyl for each segment 144 may be measured using Fourier transform infrared spectroscopy (“FTIR”) in transmission. As used herein, “in transmission” means light is directed through the glass substrate to be measured to determine the hydroxyl concentration (rather than using light reflected from the substrate to be measured to determine the hydroxyl concentration). Therefore, “in transmission” requires a non-scattering surface, e.g., a polished surface. Therefore, surfaces of the ULE glass body may be polished to facilitate measurement. Once ULE glass body 140 (e.g., sample 142) is loaded into the FTIR instrument for measurement, a beam alignment and background measurement may be performed. Then, the FTIR instrument measures the fundamental absorption peak for hydroxyl, which is a measure of the absorption peak height with respect to the background signal, the background signal being a straight line between the points surrounding the absorption peak. The absorption peak height is then divided by the thickness h of sample 142 to yield an absorption coefficient β_{OH}. The hydroxyl concentration is then derived from the absorption coefficient BOH using the equation:

$$C = {β}_{OH} / ε \times {MW}_{OH} / Dglass \times 106$$

where C is the concentration of hydroxyl in ppm for a particular segment 144, β_{OH} is the absorption coefficient of the glass, ∈ is the molar absorptivity of hydroxyl for the absorption peak at a wavenumber of 3670 cm⁻¹, MWOH is the molecular weight of hydroxyl (g/mol), and Dglass is the density of the glass (g/cm³). The above-disclosed FTIR analysis is further disclosed in K. M. Davis, et al, “Quantitative infrared spectroscopic measurement of hydroxyl concentration in silica glass,” J. Non-Crystalline Solids, 203 (1996) 27-36, which is incorporated by reference herein. As discussed above, the hydroxyl concentration may be measured for each segment 144 of sample 142 and may be measured through the full thickness of each segment 144. The hydroxyl concentration measurement may then be repeated over all segments 144 of sample 142.

The titania concentration of each segment 144 may be calculated based on the measured refractive index of each segment 144. More specifically, an optical interferometer operating at a wavelength of 633 nm may be used to measure the refractive index. In particular, the optical interferometer may be a Zygo Verifire HD from Zygo Corporation with a 270-micrometer pixel size resolution and operating at a wavelength of 633 nm. The optical interferometer may be set so the pixels are square, with a size of 270 micrometers×270 micrometers, with each pixel extending through the full thickness h of sample 142. The refractive index may be measured at each pixel within a segment 144 and through the full thickness of the pixel (e.g., segment). The refractive indices, which were each measured for each pixel within a segment 144, may then be averaged together to determine the average refractive index of each segment 144. The refractive index measurement is then repeated over all segments 144 of sample 142.

The average titania concentration of each segment 144 may be determined based on the average refractive index of each segment 144 using the following relationship:

$$Δ55 ppm RI = Δ0 \text{.0125} \% {C}_{Ti}$$

where RI represents the average refractive index of each segment 144 and C_{Ti} represents the average concentration of titania (in wt. %) of each segment 144. The above relationship assumes the only influence on the change of refractive index is from titania and equates a change of 0.0125% titania concentration to a 55-ppm change in average refractive index.

Furthermore, the average CTE of each segment 144 may be determined from the average refractive index of each segment 144 using the relationship:

$$Δ55 ppm RI = Δ1 ppb / K CTE$$

where RI represents the average refractive index of each segment 144, ppb is parts per billion, K is temperature in Kelvin, and CTE represents the average coefficient of thermal expansion (in ppb/K) of each segment 144. The above relationship assumes the only influence on the change of refractive index is from CTE.

Another feature for glass substrates, for example in EUV systems, is the temperature at which the CTE of the glass substrate is exactly equal to zero. This temperature is known as the zero-crossing temperature, Tzc. Glass substrates in EUV systems should ideally have a Tzc value near the temperature of the glass substrate when the glass substrate is used in its intended function, e.g., when it is exposed to the EUV light of an EUV system. When the Tzc value matches (or is close to) this temperature, the glass substrate will experience minimal expansion (and, thus, minimal figure distortion) during operation of the EUV system.

Tzc is directly related to hydroxyl and titania concentration in a glass substrate (at typical fictive temperature ranges). Therefore, as the titania concentration increases, Tzc will also increase. However, hydroxyl is inversely related to Tzc, so as hydroxyl concentration increases, Tzc will decrease. The concentration of hydroxyl has a larger effect on Tzc than titania concentration.

Additionally, the Tzc of each segment 144 may be determined from the CTE of each segment 144 using the following relationship:

$$Δ CTE / CTE slope = Δ Tzc$$

where ΔCTE represents the deviation of CTE for a particular segment 144 compared to the average CTE of all segments 144 (in ppb/K), CTE slope represents the slope of CTE for all the segments 144 as a function of temperature (in ppb/K²), and ΔTzc represents the deviation of Tzc for the particular segment 144 compared to the average Tzc of all the segments 144 (° C.).

The above relationship assumes the only influence on the change of Tzc is from CTE. In the embodiments disclosed herein, the CTE slope may be from about 1.0 ppb/K² to about 2.5 ppb/K², or about 1.15 ppb/K² to about 2.0 ppb/K², or about 1.2 ppb/K² to about 1.9 ppb/K², or about 1.3 ppb/K² to about 1.7 ppb/K².

One or more segments 144 may have a different concentration of one or more components from one or more other segments 144. For example, one or more segments 144 may have a different average concentration of hydroxyl from one or more other segments 144. Additionally, or alternatively, one or more segments 144 may have a different average concentration of titania from one or more other segments 144. For example, in some embodiments, segments 144 closer to the center point 148 of sample 142 may have a higher concentration of hydroxyl than segments 144 closer to the peripheral edges of sample 142. As an example, segments A, B, and C in FIG. 4 may each have higher concentration of hydroxyl than segments X, Y, and Z.

In some instances, the concentration of hydroxyl may be in a gradient that extends radially outward along sample 142 with the highest hydroxyl concentrations near center point 148 such that the segments gradually decrease in hydroxyl concentration radially outward from center point 148. In these instances, segments near center point 148 may have the highest concentration of hydroxyl while segments near the peripheral edges of sample 142 may have the lowest concentration of hydroxyl.

In yet other instances, segments 144 closer to a peripheral edge of sample 142 may have a higher concentration of hydroxyl than other segments. For example, segments Q, R, and S in FIG. 4 may each have a higher hydroxyl concentration than segments A, B, and C and higher than segments X, Y, and Z.

In still other instances, segments 144 may all have the same or substantially the same concentration of hydroxyl.

Furthermore, one or more segments 144 may have the same or different concentrations of titania. In some instances, the concentration of titania may be the same or substantially the same across segments 144. Therefore, in some embodiments, the concentration of titania may be evenly distributed among segments 144.

The average concentration of a component of each segment 144 may be averaged together to determine an average concentration of that component across the cross-section of sample 142. For example, the average concentration of hydroxyl of each segment 144 may be measured (as discussed above) and each of these concentrations may be averaged together to determine the average hydroxyl concentration across an entirety of sample 142. By way of example, in embodiments when sample 142 comprises 144 segments 144 as shown in FIG. 4, the hydroxyl concentrations of the 144 segments 144 may be averaged together to determine the average concentration of hydroxyl of the entirety of sample 142.

According to embodiments disclosed herein, the average hydroxyl concentration of the entirety of sample 142 may be in a range from about 0 ppm to about 2000 ppm, in a range from about 200 ppm to about 1900 ppm, in a range from about 300 ppm to about 1800 ppm, in a range from about 400 ppm to about 1700 ppm, in a range from about 500 ppm to about 1750 ppm, in a range from about 600 ppm to about 1600 ppm, in a range from about 700 ppm to about 1500 ppm, in a range from about 800 ppm to about 1400 ppm, in a range from about 900 ppm to about 1300 ppm, in a range from about 1000 ppm to about 1200 ppm, in a range from about 1000 ppm to about 1100 ppm, in a range from about 600 ppm to about 1500 ppm, in a range from about 600 ppm to about 1400 ppm, in a range from about 600 ppm to about 1300 ppm, in a range from about 700 ppm to about 1000 ppm, in a range from about 50 ppm to about 200 ppm, in a range from about 75 ppm to about 150 ppm, or in a range from about 80 ppm to about 125 ppm, including all ranges and subranges therebetween. In some embodiments, the average hydroxyl concentration of the entirety of sample 142 may be about 400 ppm or less, about 350 ppm or less, about 300 ppm or less, about 250 ppm or less, about 200 ppm or less, about 150 ppm or less, about 100 ppm or less, about 90 ppm or less, about 80 ppm or less, about 75 ppm or less, about 70 ppm or less, about 60 ppm or less, or about 50 ppm or less. In some embodiments, the average value of hydroxyl (OH) concentration in the silica-titania glass may be in a range from about 100 parts per million weight (ppmw), to about 1000 ppmw, in a range from about 200 ppmw to about 900 ppmw, in a range from about 300 ppmw to about 800 ppmw, or in a range from about 400 ppmw to about 700 ppmw, including all ranges and subranges therebetween.

In some embodiments, the maximum hydroxyl concentration among segments 144 may be in a range from about 1000 ppm to about 1400 ppm, in a range from about 1000 ppm to about 1300 ppm, in a range from about 1000 ppm to about 1200 ppm, in a range from about 1000 ppm to about 1100 ppm, in a range from about 1050 ppm to about 1100 ppm, or in a range from about 1060 ppm to about 1090 ppm, including all ranges and subranges therebetween. The minimum hydroxyl concentration among segments 144, in some embodiments, may be in a range from about 900 ppm to about 1300 ppm, in a range from about 900 ppm to about 1200 ppm, in a range from about 900 ppm to about 1100 ppm, in a range from about 1000 ppm to about 1100 ppm, in a range from about 1050 ppm to about 1100 ppm, or in a range from about 1060 ppm to about 1080 ppm, including all ranges and subranges therebetween.

In embodiments, the hydroxyl (OH) concentration of the silica-titania glass may not vary more than +40 ppmw, or +30 ppmw, or +20 ppmw, or +10 ppmw, or +5 ppmw relative to an average value of hydroxyl (OH) concentration in the silica-titania glass, including all ranges and subranges therebetween.

The average titania concentration of the entirety of sample 142 may be in a range from about 1.0 wt. % to about 15.0 wt. %, in a range from about 6.0 wt. % to about 12.0 wt. %, in a range from about 6.0 wt. % to about 8.5 wt. %, in a range from about 6.5 wt. % to about 8.0 wt. %, in a range from about 7.0 wt. % to about 7.7 wt. %, or in a range from about 6.5 wt. % to about 7.8 wt. %, including all ranges and subranges therebetween.

The difference between the highest average concentration and the lowest average concentration of the one or more components among the different segments 144 may also be determined. More specifically, the segment 144 with the highest average concentration of a particular component (e.g., hydroxyl or titania) may be compared with the segment 144 with the lowest average concentration of that component. Then, the difference between the highest and lowest average concentrations of that component may be calculated. This difference between the highest average concentration and the lowest average concentration in a sample 142 is referred to as the peak-to-valley (P-V) difference in average concentration.

Additionally, as discussed above, the average Tzc, average refractive index, and average CTE of each segment 144 may be determined. One or more segments 144 may differ in these properties from one or more other segments 144. Therefore, for example, a first segment 144 may have a different average Tzc and/or a different average refractive index from a second segment 144.

FIG. 6 shows an exemplary plot 160 of average hydroxide concentration of each segment radially outward from center 148 of a sample 142, according to embodiments disclosed herein. The plot of FIG. 6 is taken along the length L″ of sample 142 from center point 148 radially outwards. As shown in the exemplary embodiment of FIG. 4, the segments 144 with the highest average concentrations of hydroxide may be located near the center point 148 and the segments with the lowest average concentration of hydroxide may be located at the radially peripheral ends of sample 142. In particular, in the plot shown in FIG. 6, the average concentration of hydroxyl is highest at the Max_{OH} position and lowest at the Min_{OH} position. Therefore, the P-V difference is the difference between the average hydroxyl concentrations at the Max_{OH} and Min_{OH} locations. However, as also discussed above, the distribution of hydroxyl may vary in other embodiments such that, for example, the Max_{OH} position may be located at a peripheral edge of sample 142 and/or the Min_{OH} position may be located near the center point 148.

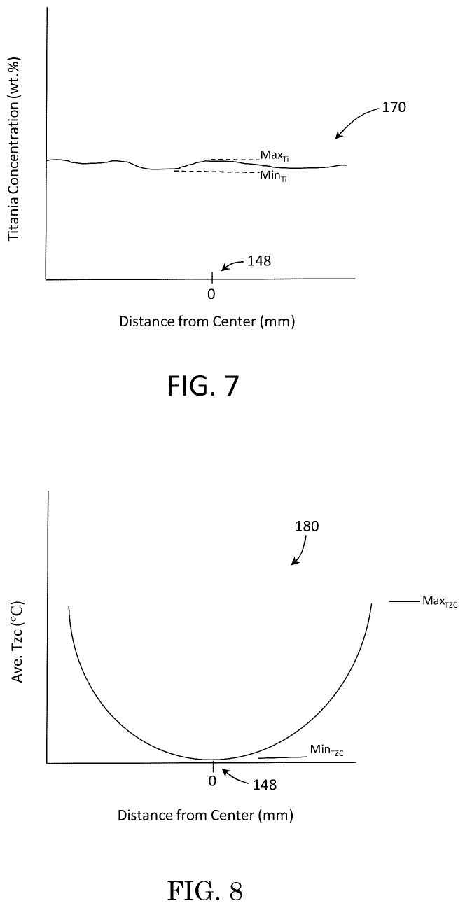

FIG. 7 shows an exemplary plot 170 of average titania concentration of each segment 144 radially outward from center 148 of a sample 142, according to embodiments disclosed herein. The plot 170 of FIG. 7 is taken along the length of sample 142 from the center point 148 radially outwards (similar to that of FIG. 6). As shown in FIG. 7, the average concentration of titania of segments 144 is approximately equal near the center point 148 and at the radially peripheral ends of sample 142 with little variation in the average concentration of titania. However, even the small variation in the average titania concentration may still produce a maximum titania concentration at the Maxi position and a minimum titania concentration at the Mini position. Therefore, the P-V difference is the difference between the average titania concentrations at the Max_{Ti} and Min_{Ti} positions.

FIG. 8 shows an exemplary plot 180 of average Tzc of each segment 144 radially outward from center 148 of a sample 142 according to embodiments disclosed herein. The plot 180 of FIG. 8 is taken along the length of sample 142 from the center point 148. As shown in the exemplary embodiment of FIG. 4, the segments 144 with the lowest average Tzc may be located near the center point 148 and the segments 144 with the highest average Tzc may be located at the peripheral ends of sample 142. In the exemplary plot 180 shown in FIG. 8, the average Tzc is highest at the Max_{Tzc} position and lowest at the Min_{TZC} position. Therefore, the P-V difference is the difference between the average Tzc at the Max_{Tzc} and Min_{TZC} positions. However, the distribution of average Tzc may vary in other embodiments such that, for example, the Max_{TZC} position may be located at a peripheral edge of sample 142 and/or the Min_{TZC} position may be located at the center point 148.

The P-V difference of average Tzc in segments 144 across sample 142 may be in a range from about 0.050° C. to about 0.300° C., in a range from about 0.075° C. to about 0.250° C., in a range from about 0.080° C. to about 0.200° C., in a range from about 0.100° C. to about 0.190° C., in a range from about 0.120° C. to about 0.180° C., in a range from about 0.140° C. to about 0.160° C., in a range from about 0.050° C. to about 0.180° C., or in a range from about 0.100° C. to about 0.140° C., including all ranges and subranges therebetween.

Due to the low P-V difference of average T_{zc} in segments 144, ULE glass body 140 may be able to maintain its surface shape (“figure”) when subject to temperature changes in an EUV lithography system.

When comparing FIGS. 6 and 8, the Max_{OH} position is located at the Min_{Tzc} position on sample 142. Therefore, in these embodiments, the segment(s) 144 with the maximum concentration of hydroxyl may also have the minimum Tzc. Furthermore, in these embodiments, the segments 144 with relatively higher hydroxyl concentration may have relatively lower Tzc.

The average T_{zc} of segments 144 across the entirety of sample 142 may be in a range from about 20° C. to about 60° C., in a range from about 25° C. to about 55° C., in a range from about 30° C. to about 50° C., in a range from about 35° C. to about 45° C., in a range from about 40° C. to about 45° C., in a range from about 20° C. to about 45° C., in a range from about 20° C. to about 40° C., or in a range from about 10° C. to about 50° C., including all ranges and subranges therebetween.

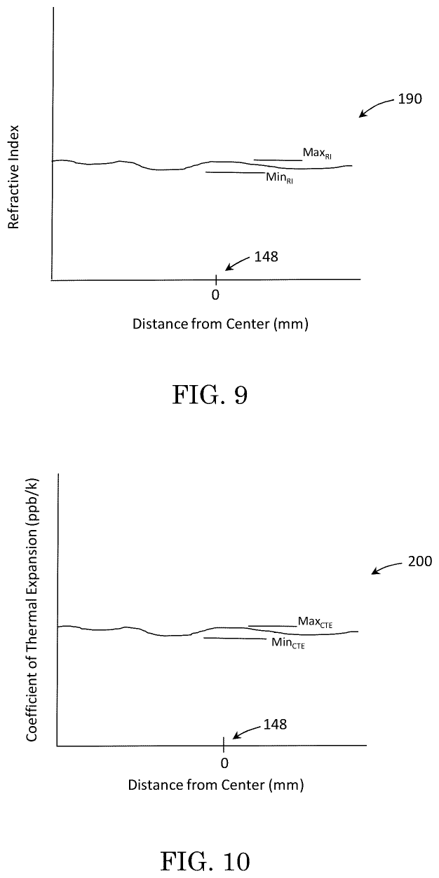

FIG. 9 shows an exemplary plot 190 of average refractive index of segments 144 radially outward from the center of a sample 142 according to embodiments disclosed herein. The plot 190 of FIG. 9 is taken along the length of sample 142 from the center point 148. Furthermore, when compared with plot 170 (as shown in FIG. 7), the average refractive index of segments 144 across sample 142 is similar to the average concentration of titania of segments 144 across sample 142. As shown in FIG. 9, the average refractive index is approximately equal near the center point 148 and at the radially peripheral ends of sample 142 with little variation in the average refractive index. However, the small variation in the average refractive index may still produce a maximum amount at the Max_{RI} position and a minimum amount at the Min_{RI} position. Therefore, the P-V difference is the difference between the average refractive index at the Max_{RI} and Min_{RI} positions.

The P-V difference of average refractive index of segments 144 across sample 142 may be about 1×10⁻⁴ or less, about 5×10⁻⁵ or less, about 1×10⁻⁵ or less, about 5×10⁻⁶ or less, about 1×10⁻⁶ or less, about 5×10⁻⁷ or less, or about 1×10⁻⁷ or less. The P-V difference of average refractive index of segments 144 across sample 142 may be in a range from about 1×10⁻⁶ to about 1×10⁻⁴, in a range from about 6×10⁻⁶ to about 9×10⁻⁵, in a range from about 10×10⁻⁶ to about 6×10⁻⁵, in a range from about 1×10⁻⁶ to about 1×10⁻⁵, or in a range from about 1×10⁻⁵ to about 1×10⁻⁴, including all ranges and subranges therebetween. The distribution of refractive index within a glass body is an indicator of the titania concentration distribution of that glass substrate. Therefore, a glass substrate with a smaller P-V difference in refractive index may also have a smaller P-V difference of titania. As discussed above, a smaller P-V difference of titania allows the glass body, e.g., a glass substrate, to be more uniformly polished.

FIG. 10 shows an exemplary plot 200 of average CTE of segments 144 radially outward from the center of a sample 142 according to embodiments disclosed herein. The plot 200 of FIG. 10 is taken along the length L′ of sample 142 from the center point 148. Furthermore, when comparing with plot 190 (shown in FIG. 9), the average CTE of segments 144 across sample 142 is similar to the average concentration of titania of segments 144 and similar to the average refractive index of segments 144 across sample 142. As shown in FIG. 10, the average CTE is approximately equal near the center point 148 and at the radially peripheral ends of sample 142 with little variation in the average CTE. However, the small variation in the average CTE may still produce a maximum amount at the Max_{CTE} position and a minimum amount at the Min_{CTE} position. Therefore, the P-V difference is the difference between the average CTE at the Max_{CTE} and Min_{CTE} positions.

The P-V difference of average CTE of segments 144 across sample 142 may be about 0.30 ppb/K or less, about 0.25 ppb/K or less, about 0.20 ppb/K or less, about 0.15 ppb/K or less, about 0.12 ppb/K or less, about 0.10 ppb/K or less, or about 0.05 ppb/K or less. In embodiments, the P-V difference of average CTE of segments 144 across a sample may be in a range from about 0.05 ppb/K to about 0.25 ppb/K, from about 0.07 ppb/K to about 0.20 ppb/K, from about 0.08 ppb/K to about 0.18 ppb/K, from about 0.09 ppb/K to about 0.16 ppb/K, or from about 0.10 ppb/K to about 0.15, including all ranges and subranges therebetween.

The average CTE of each segment 144 may be about −30 ppb/K to about +30 ppb/K at a temperature between 288K and 303K. In some embodiments the CTE may be from about −10 ppb/K to about +10 ppb/K at a temperature between 288K and 303K, from about −5 ppb/K to about +5 ppb/K at a temperature between 288K and 303K, or from about −2 ppb/K to about +2 ppb/K, including all ranges and subranges therebetween, at a temperature between 288K and 303K.

Given that CTE may undesirably vary across and within a ULE sample, methods for modifying CTE in ULE glasses by deterministic correction rather than striving for improved uniformity of the raw (as manufactured) ULE glass are disclosed.

In embodiments, a pulsed and focused laser beam may be directed through a surface of a ULE glass body, e.g., to an interior volume of the ULE glass body, for example a ULE glass substrate, whereupon energy from the laser beam is locally absorbed in the glass through a non-linear absorption process. Non-linear absorption at the focus of the pulsed laser beam leads to large absorption and heat generation on a local scale. This small volume of heat-affected glass exhibits an increase in thermal expansion compared to the bulk glass, an effect that can be attributed to reorganization of the glass network, formation of small titania clusters, and gradual ordering thereof to form titania paracrystals or crystal nuclei. By selecting appropriate process conditions, residual stress can be kept at an acceptable level without damage (e.g., breaking) to the glass. Stress in the glass may be further reduced by annealing.

Methods disclosed herein may allow for measurement of CTE homogeneity to be used as a guide for laser correction, for example to create an extremely flat CTE profile, or to achieve a desired CTE profile, currently unachievable by other means.

Compared with other CTE control approaches that focus on, for example, creating completely uniform TiO₂ throughout the entire ULE glass body (e.g., bulk modification), localized laser modification offers a high precision, repeatable, and easily adjustable method for altering the thermal expansion behavior of ULE glass.

By constructing a modified CTE profile through selective laser processing, this method offers a way to achieve a tailored expansion behavior and/or stress property in three dimensions, such as, for example, substrates containing specially designed tension and/or compression stress profiles, quantum information processing, thermo-compensated mechanical devices, etc.

### EXAMPLE

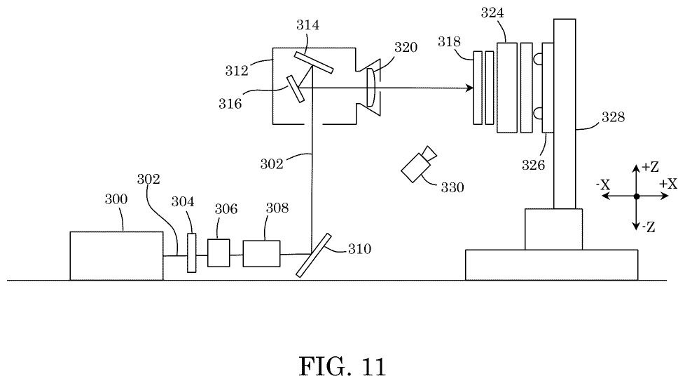

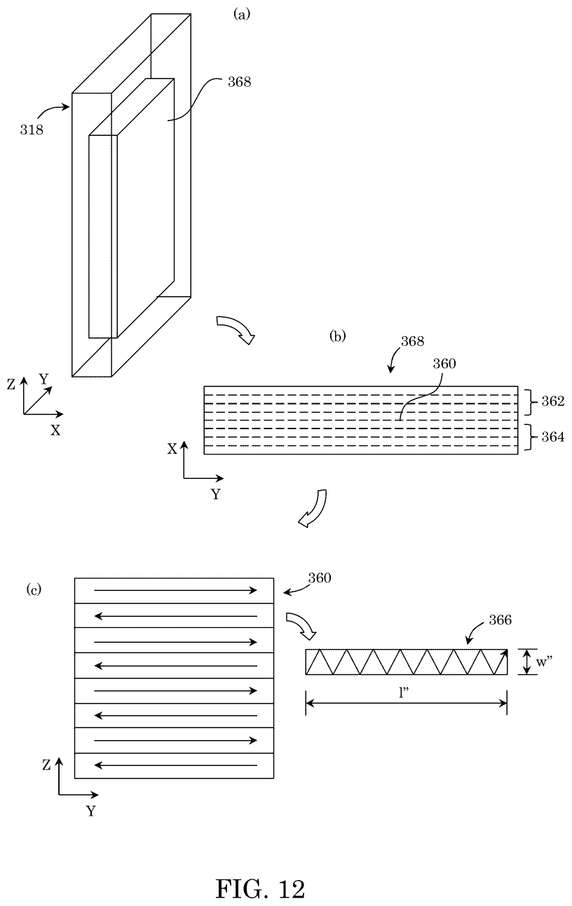

A Nd: YAG laser 300 (800 kHz Trumpf Micro 5050C) was used to produce a pulsed laser beam 302 with a pulse duration of 10 picoseconds (ps) at a wavelength of 1030 nanometers (nm), as shown in FIG. 11. The pulsed laser beam was passed through a one-half wave (2/2) plate 304, a beam splitter 306, and the beam diameter was increased by a beam expander 308. One half wave plate 304 and beam splitter 306 are used to control laser power by controlling the polarization of the laser beam, and the amount of polarized light transmitted. The expanded laser beam (14 mm in diameter) was directed by a directing mirror 310 to a galvo scan system 312 (excelliSCAN 14) capable of varying laser beam directivity in different directions through deflection by two scanning mirrors, a first scanning mirror 314 and a second scanning mirror 316. The laser beam was focused on a ULE glass body 318 (see FIG. 12(a)) using an F-theta focusing lens 320 (45 mm in focal length), resulting in an about 4.22 micrometer (μm) diameter focus spot on the ULE glass body. The ULE glass body was a glass substrate comprising parallel major surfaces. A vacuum clamping system 322, including a vacuum chuck 324 and a tile platform 326, was fixed on a computer-controlled X-Y-Z motion stage 328 to provide precise sample positioning and movement during processing. The glass body was oriented such that movement in the X direction represented movement in a thickness direction of the ULE glass body, and the Z-Y dimension was parallel to the major surfaces of the ULE glass body. A camera 330 was used to collect fluorescence emitted from the laser focus allowing a determination of the focus location in the glass.

Laser beam 302 was first focused on the middle plane 360 of the ULE glass body 318 and moved “up” in a layer-by-layer (plane-by-plane) manner by adjusting the position of the motion stage along the X motion axis of the motion stage, as shown in FIG. 12(b). After processing of multiple planes 360 located in a first half part 362 of the ULE glass body was completed, the ULE glass body was flipped to enable laser processing of planes 360 contained in the opposite (e.g., second) half 364 of the ULE glass body. In each layer (plane), an area of about 20 mm by about 43 mm in the Z-Y plane was laser treated using an on-the-fly scanning strategy. First, while motion stage 328 was used to continuously move the ULE glass body along the Y axis, the galvo scan system rastered (moved in a zig-zag motion) the laser beam 302 along the Z axis (w=0.5 mm, speed vₛ=2 m/s), with laser beam 302 following a triangular path on the ULE glass body surface, as shown in FIG. 12(c) (this scanning strategy could also be achieved using a polygonal mirror scanner with even higher processing speed). Therefore, a modification path 366 with a width w″ of 0.5 mm and length l″ of 20 mm was followed on the ULE glass sample. Next, ULE glass sample 318 was moved along the Z axis with an overlap of about 20% to form a second modification path, again rastering the laser beam. This process was repeated until the entire 20 mm by 43 mm area 368 was laser treated. Three ULE glass bodies 318 were processed with different laser pulse energies and layer numbers. Table 1 summarizes the processing parameters. To compare each ULE glass body and the resulting CTE modification, the energy density was defined by the total laser energy delivered to a 1 mm³ volume. The energy density ranged from 1.85 J/mm³ to 4.43 J/mm³, while the processing time ranged from about 1 to about 2 hrs.

TABLE 1

| Parameter | Symbol | Unit | Sample 1 | Sample 2 | Sample 3 |
|---|---|---|---|---|---|
| Wavelength | λ | μm | 1.03 | 1.03 | 1.03 |
| Beam Diameter | wi | mm | 14 | 14 | 14 |
| Lens focal Length | F | mm | 45 | 45 | 45 |
| Focal Spot | 2 [symbol] ₒ | μm | 4.22 | 4.22 | 4.22 |
| Diameter | | | | | |
| Rayleigh range | Z_{R} | μm | 13.56 | 13.56 | 13.56 |
| Frequency | f | kHz | 800 | 800 | 800 |
| Laser Power | P | W | 6.4 | 4.8 | 4.8 |
| Pulse Energy | E | μJ | 8 | 6 | 6 |
| Feed Rate | V_{F} | mm/s | 10 | 10 | 10 |
| Scanning Speed | V_{S} | mm/s | 2000 | 2000 | 2000 |
| Processed Width | w | mm | 20 | 20 | 20 |
| Single Scan | l | mm | 0.5 | 0.5 | 0.5 |
| Width | | | | | |
| Layer number | N | | 11 | 9 | 6 |
| Processed volume | V_{M} | % | 23.65 | 28.62 | 22.26 |
| percentage | | | | | |
| Energy Density | E_{ED} | J/mm² | 4.43 | 2.71 | 1.85 |
| Processing Time | t | hrs | ~2 | ~1.2 | ~1 |

Without wishing to be bound by theory, it is believed the laser treatment resulted in a change of titanium from ^{[4]}Ti to ^{[6]}Ti, triggering the formation of small titania clusters with up to three titanium atoms with Ti—O—Ti bonding and gradual ordering to form titania paracrystals or crystal nuclei. The crystalline titania phases are expected to have significantly higher CTE. Therefore, the change from ^{[4]}Ti to ^{[6]}Ti results in an increased CTE compared with regions not laser processed.

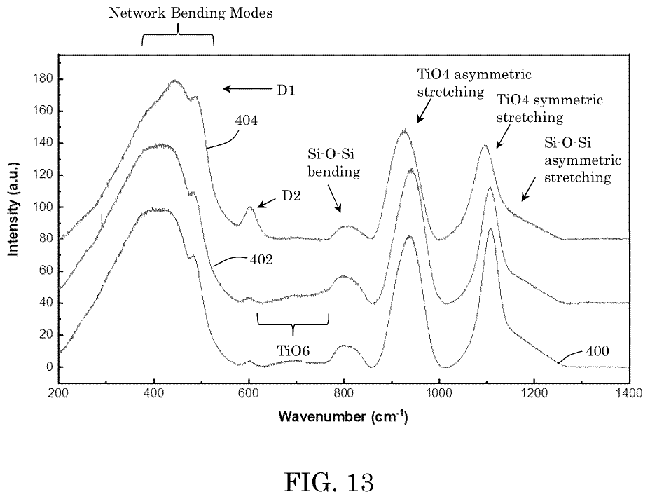

FIG. 13 is a normalized Raman spectra for pristine, exposed, and overexposed ULE glass, where curve 400 represents pristine (untreated) glass, curve 402 represents exposed glass, and curve 404 represents overexposed glass. The Raman band assignments are listed in Table 2.

TABLE 2

| | Pristine | Exposed | Over Exposed |
|---|---|---|---|
| Band Assignment | ULE | ULE | ULE |
| Symmetric stretching-bending of | 398.03 | 404.08 | 415.14 |
| Si—O—Si brides in large | | | |
| arrangements such as five-to-eight | | | |
| membered silicate ring structures | | | |
| 4-membered silicate | 483.61 | 444.72 | 482.12 |
| ring breathing mode D1 | | | |
| 3-membered silicate | 603.01 | 602.51 | 597.08 |
| ring breathing mode D2 | | | |
| TiO6 symmetric stretching | 699.48 | 689.26 | 707.25 |
| SiO—Si bending | 803.12 | 804.08 | 798.82 |
| TiO4 asymmetric stretching | 934.64 | 929.02 | 942.60 |
| TiO4 symmetric stretching | 1109.42 | 1096.06 | 1108.04 |
| SiO—Si asymmetric stretching | 1188.52 | 1189.43 | 1189.4 |

The ratio of TiO₄ related peaks R=I₁₁₀₇/I₉₄₀, where I represents intensity, was reduced after laser treatment. In previous work, observation of the ratio change (1−R) as a function of temperature was correlated with trends in the expansion curves of various TiO₂-SiO₂ glass. This relationship mimics the trends seen in the glass expansion. Similarly, regarding the present case, reduced R could be used to mimic the CTE trend caused by laser treatment, indicating an increased CTE compared with pristine regions.

The network bending mode shift from 400 cm⁻¹ to 430 cm⁻¹ appears to behave more like fused silica (shift to higher wavenumbers), suggesting a reorganization of the ULE glass network and an increase in CTE.

The D2 band increased after laser processing associated with 3-member silicate rings. An increase in D2 is associated with an increase in fictive temperature T_{f}. The higher T_{f} is expected to decrease CTE and increase the expansivity slope.

The band width of ^{[4]}Ti could reflect the chemistry (e.g., bonding characteristics) of TiO₄ tetrahedra. Laser irradiation was found to increase both bandwidths of ^{[4]}Ti, suggesting a broader distribution of TiO₄ sites in laser treated ULE glasses. In several series of tetrahedral oxoanions the frequencies of both symmetric and asymmetric stretching modes decrease as the oxidation state of the metal is lowered. On this basis, the apparent frequency reduction reflects the formation of TiO₄ tetrahedral sites of Ti³⁺ in addition to the remaining TiO₄ tetrahedral sites of Ti⁴⁺ ions. Darkening of the laser-exposed glass after laser irradiation was observed and is believed to have been caused by this photoreduction process.

Crystals by nature have a positive and directional expansion and their relationship to the overall glass expansion is important. Therefore, the overall CTE increase may be attributable to reorganization of the glass network, formation of small titania clusters, and gradual ordering to form titania paracrystals or crystal nuclei by laser treatment.

Thus, Raman investigation suggests structural changes occur in the glass after laser treatment, beyond simple modification of the glass fictive temperature. The changes seem to be consistent with the formation of crystal phases.

After laser exposure, a laser treated ULE glass body was annealed. It was observed that the decrease of Tzc by laser exposure was seemingly erased after a relatively mild anneal, but the low CTE slope was preserved. The measured Tzc and CTE slope for the body after each treatment step are listed in Table 3. The original ULE glass body after standard anneal (e.g., a stress-relieving anneal after forming of the ULE glass body), which was considered the “as-made” state of the glass, had a Tzc of 49° C. and a CTE slope of 1.60 ppb/K². The next (1^{st}) anneal step shifted the Tzc to 38° C. and the CTE slope to 1.60 ppb/K². The laser treatment further decreased the Tzc to 30° C. and increased the CTE slope to 1.385 ppb/K². A subsequent (2^{nd}) anneal step was performed comprising a temperature hold at 790° C. for 4 hrs. followed by cooling to room temperature at a rate of 20° C./min, which increased Tzc back to 45° C. while preserving the low CTE slope.

TABLE 3

| Sample Treatment | T_{ZC} | CTE Slope |
|---|---|---|
| Original ULE after standard anneal | 49° C. | 1.6 |
| 1^{st} anneal | 38° C. | 1.304 |
| Laser Exposure | 30° C. | 1.385 |
| 2^{nd} anneal | 45° C. | 1.385 |

A laser exposed ULE glass body was mechanically diced to small pieces to view the cross-section stress profile. However, measurement of retardation through the exposed region was hampered by permanent photodarkening. Therefore, the magnitude of retardation in the exposed region was not accurate. A new sample was prepared with one layer and two layers of laser modification using a 1 mm thick ULE glass substrate for reduced optical path length and increased optical transmission, after which retardation and slow axis orientations were detectable through the sample thickness. In the laser modified region, the slow axis orientation was found to be vertical to the sample movement direction (aligned with galvo scanner direction and vertical to stage translating direction). In the surrounding material, the slow lines were parallel to movement direction. It is believed that after laser irradiation, the modification volume rapidly cools down and contracts. The surrounding material resists and develops a strain field in compression. Similarly, the residual stress between layers shown in cross-section is in compression in the non-treated region.

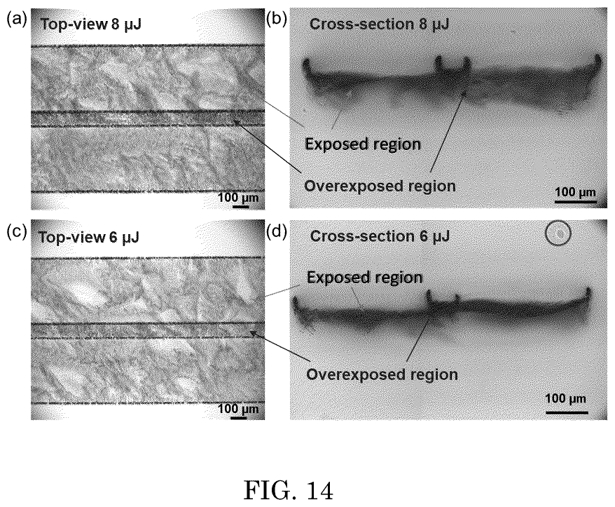

FIG. 14 shows images of single layer laser modification with different laser pulse energies. Two modification paths were generated inside each sample with a 0.5 mm width and 20% overlap. FIG. 14(a) is a top view of a portion of a ULE glass body showing two modification lines (top and bottom) obtained with 8 μJoules of laser power incident on the glass substrate, and a narrow overlap region therebetween. FIG. 14(b) shows the ULE glass body in cross-section. The photodarkening resulting from the exposure is clearly visible. The increased darkening resulting from overexposure in the overlap region is also visible. FIG. 14(c) is a top view of a portion of a ULE glass body showing two modification paths (top and bottom) obtained with 6 μJoules of laser power incident on the ULE glass body, and a narrow overlap region therebetween. FIG. 14(d) shows the ULE glass body in cross-section. The photodarkening resulting from the exposure is clearly visible. The increased darkening resulting from overexposure in the overlap region is also visible. At the two edges of each path the galvo scanner changed scanning directions, resulting in more pulse overlap and increased energy density compared with the center. Also, portions of the glass between the two edges were exposed to laser radiation twice due to the 20% overlap. Therefore, the overlapped region was defined as the “overexposed region,” as labeled in the cross-section images.

The effect of laser treatment on ULE glass expansion behavior is summarized in Table 4.

TABLE 4

| Laser | | | |
|---|---|---|---|
| Modification | Raman Spectra Change | Analysis | Effect on CTE |
| Exposed | Increased intensity of | Change of ^{[4]}Ti to | Increase in CTE |
| Region | TiO₆ stretching | ^{[6]}Ti, triggers the | |
| | (700 cm⁻¹) | formation of small | |
| | | Ti clusters, gradual | |
| | | ordering to form | |
| | | titania paracrystals | |
| | | or crystal nuclei | |
| | Reduced intensity ratio | Mimic the trend in | Increase in CTE |
| | of I₁₁₀₇/I₉₄₀ | glass expansion | |
| | | caused by structural | |
| | | change | |
| Overexposed | Main silica-type band | Silicate structure | Increase in CTE |
| Region | shifts from about 400 to | rearrangement, | |
| | 430 cm⁻¹ | formation of silica | |
| | | glass | |
| | Increased intensity of | Silicate structure | Increased fictive |
| | 600 cm⁻¹ peak (D2) | rearrangement with | temperature, |
| | | increased defects | Decrease in CTE |
| | | formation | |
| | Reduced intensity TiO₄- | Reduction in the | Increase in CTE |
| | related peaks (937 and | population of TiO₄ | |
| | 1107 cm⁻¹) | unit | |
| | Reduced frequency of | Reduction of Ti⁴⁺ to | Unknown |
| | TiO₄-related peaks (937 | Ti³⁺ | |
| | and 1107 cm⁻¹) | | |
| | Reduced intensity ratio | Mimic the trend in | Increase in CTE |
| | of I₁₁₀₇/I₉₄₀ | glass expansion | |
| | | caused by structural | |
| | | change | |

In the pulsed laser irradiation process disclosed herein, the local heating caused by high repetition rate laser radiation exposure leads to thermal expansion of the glass, resulting in stress in the surrounding unexposed material. Not all the stress can be released after rapid quenching, and the resulting residual stress can cause cracking and limit the use of post laser mechanical processes like cutting and/or polishing. Therefore, a strain scope was used to measure the magnitude and orientation of optical retardation after laser processing. Its principle, based on the effect of residual stress on the phase delay of the two component waves of a polarized light beam passing through the glass, allows a theoretically non-destructive assessment of the residual stress state.

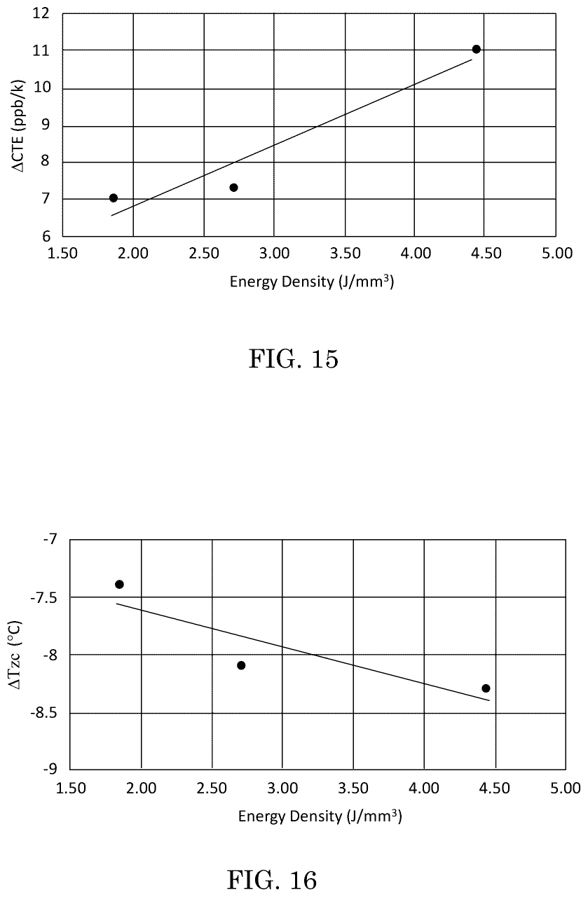

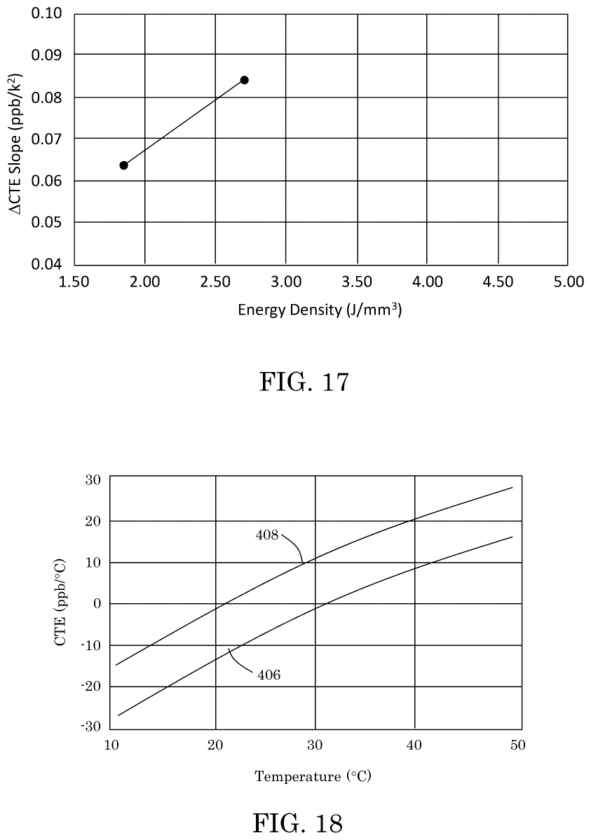

FIGS. 15-17 show the measured expansion behavior after laser processing. FIG. 15 is a plot of the change in CTE as a function of energy density, FIG. 16 is a plot of Tzc as a function of energy density, and FIG. 17 is a plot of the change in CTE slope as a function of energy density. The data show that when deposited energy increased from 1.85 J/mm³ to 4.43 J/mm³, ACTE increased from 7.05 ppb/K to 11.03 ppb/K and the cross-over temperature Tzc changed from −7.34° C. to −8.3° C. The slope change was also increased with the increase in energy deposition. Moreover, the data show that CTE and slope change nearly linearly with energy density, a trend which is also expected with pulse rate and duration.

The expansion behavior of a ULE glass body over a temperature range from 10° C. to 50° C. was measured using high resolution dilatometry both before (curve 406) and after (curve 408) laser processing as described above and shown in FIG. 18. The data show the increase in CTE after laser exposure.

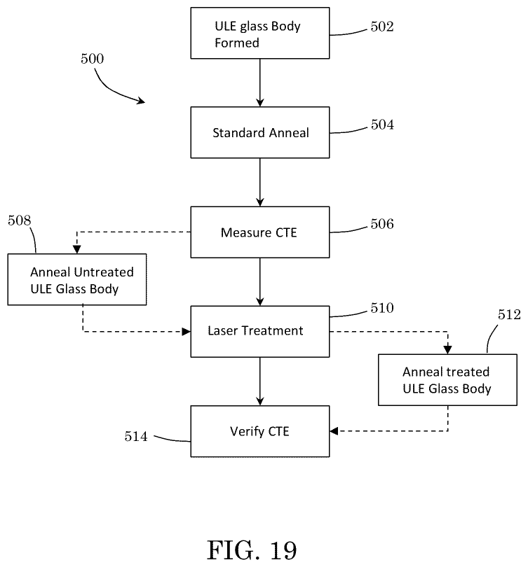

In view of the preceding, a method 500 of modifying the CTE of a ULE glass body is shown in FIG. 19 and described as follows. In a first step 502, a ULE glass body, such as a boule, wafer, substrate, is manufactured, either according to methods disclosed herein, or other methods of ULE glass manufacture. Such methods of manufacturing ULE glass typically include a standard anneal step 504 to relieve stresses that may be imparted to the glass during manufacture. The glass body comprises SiO₂ in a range from about 80 wt. % to about 99 wt. % and TiO₂ in a range from about 4 wt. % to about 11 wt. %

In a next step 506, a CTE of the ULE glass body, or a portion thereof, is measured, wherein the glass body (or the portion thereof) comprises at least a first region and a second region. The CTE values may be used to produce a map, e.g., a three-dimensional map of CTE, thereby facilitating a strategy for laser treatment of the ULE glass body.

In an optional step 508, the ULE glass body may undergo a first anneal after the standard anneal but before laser treatment. Annealing typically has the effect of lowering an overall (e.g., average) CTE of the ULE glass body. The anneal may comprise, for example, heating the glass body to an annealing temperature in a range from about 700° C. to about 950° C., such as in a range from about 750° C. to about 950° C., in a range from about 800° C. to about 950° C., or in a range from about 850° C. to about 950° C., including all ranges and subranges therebetween. The glass body may be held at a temperature, or a plurality of temperatures, in the annealing temperature range for a period of time in a range from about 1 hour to about 100 hours, for example in a range from about 2 hours to about 100 hours, in a range from about 4 hours to about 100 hours, in a range from about 8 hours to about 100 hours, in a range from about 16 hours to about 100 hours, in a range from about 30 hours to about 100 hours, in a range from about 60 hours to about 100 hours, or in a range from about 80 hours to about 100 hours, including all ranges and subranges therebetween.

In a next step 510, a pulsed laser beam is directed to at least one of the first region or the second region to modify at least one of a first CTE of the first region or a second CTE of the second region. The first CTE may be different from the second CTE either before the directing or after the directing. For example, if the first CTE is less than the second CTE prior to directing the laser beam, the directing may comprise directing the pulsed laser beam at the first region of the glass body to increase the first CTE. On the other hand, if the first CTE is greater than the second CTE prior to directing the laser beam, the directing may comprise directing the pulsed laser beam at the second region of the glass body to increase the second CTE. In some embodiments, the first CTE may be equal to the second CTE prior to the directing, wherein the directing the pulsed laser beam forms a desired difference between the first CTE and the second CTE after the directing (i.e., after exposure of the first regions and/or the second region to the pulsed laser beam).

A pulse repetition rate of the pulsed laser beam may be in a range from about 100 kHz to about 1 GHz, for example in a range from about 200 kHz to about 1 GHZ, in a range from about 300 kHz to about 1 GHz, in a range from about 400 kHz to about 1 GHz, in a range from about 500 kHz to about 1 GHz, in a range from about 600 kHz to about 1 GHz, in a range from about 700 kHz to about 1 GHz, in a range from about 800 kHz to about 1 GHz, in a range from about 900 kHz to about 1 GHz, in a range from about 100 kHz to about 900 kHz, in a range from about 100 kHz to about 800 kHz, in a range from about 100 kHz to about 700 kHz, in a range from about 100 kHz to about 600 kHz, in a range from about 100 kHz to about 500 kHz, in a range from about 100 kHz to about 400 kHz, in a range from about 100 kHz to about 300kHz, or in a range from about 100 kHz to about 200 kHz, including all ranges and subranges therebetween.

An energy density of the pulsed laser beam may be in a range from about 0.1 J/mm³ to about 50 J/mm³, for example in a range from about 0.1 J/mm³ to about 40 J/mm³, in a range from about 0.1 J/mm³ to about 30 J/mm³, in a range from about 0.1 J/mm³ to about 20 J/mm³, in a range from about 0.1 J/mm³ to about 10 J/mm³, in a range from about 0.1 J/mm³ to about 1 J/mm³, in a range from about 1 J/mm³ to about 50 J/mm³, in a range from about 10 J/mm³ to about 50 J/mm³, in a range from about 20 J/mm³ to about 50 J/mm³, in a range from about 30 J/mm³ to about 50 J/mm³, in a range from about 40 J/mm³ to about 50 J/mm³, including all ranges and subranges therebetween.

A wavelength of the pulsed laser beam may be in a range from about 780 nm to about 1100 nm, for example in a range from about 800 nm to about 1100 nm, such as in a range from about 900 nm to about 1100 nm, or in a range from about 1000 nm to about 1100 nm. The pulsed laser beam may originate from, for example, a neodymium-based laser, e.g., a Nd:YAG laser.

The laser beam comprises a focus point, and the directing may comprise producing relative motion between the focus point and the glass body. For example, the producing relative motion may comprise varying a position of the focus point within the glass body relative to a surface of the glass body on which the laser beam is incident. That is, the focus point may be moved through a thickness of the glass body. In embodiments, the focus point may be moved in a direction parallel with a plane of the glass body (e.g., parallel with a major surface of the glass body). For example, the glass body may be a glass plate comprising a first major surface and a second major surface parallel or substantially parallel with the first major surface. Accordingly, the relative motion may comprise moving the focus point parallel with either one or both of the first major surface or the second major surface. The relative motion may comprise movement of the focus point parallel with either one or both of the first major surface or the second major surface combined with movement of the focus point in a thickness direction of the glass body, the thickness of the glass body define between the first major surface and the second major surface.

The method may comprise an optional step 512 comprising annealing the ULE glass body after laser treatment. The anneal may comprise, for example, heating the glass body to an annealing temperature in a range from about 700° C. to about 950° C., such as in a range from about 750° C. to about 950° C., in a range from about 800° C. to about 950° C., or in a range from about 850° C. to about 950° C., including all ranges and subranges therebetween. The glass body may be held at a temperature, or a plurality of temperatures, in the annealing temperature range for a period of time in a range from about 1 hour to about 100 hours, for example in a range from about 2 hours to about 100 hours, in a range from about 4 hours to about 100 hours, in a range from about 8 hours to about 100 hours, in a range from about 16 hours to about 100 hours, in a range from about 30 hours to about 100 hours, in a range from about 60 hours to about 100 hours, or in a range from about 80 hours to about 100 hours, including all ranges and subranges therebetween.

After laser treatment of the ULE glass body, the CTE of the glass body may be again measured in an optional step 514 to verify the desired CTE profile.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made to embodiments of the present disclosure without departing from the scope of the disclosure. Thus, it is intended that the present disclosure cover such modifications and variations provided they come within the scope of the appended claims and their equivalents.

What is claimed is:

1. A method of modifying a coefficient of thermal expansion (CTE) of an ultra-low expansion glass, comprising:
determining a spatial CTE distribution of a glass body comprising SiO₂ in a range from about 80 wt. % to about 99 wt. % and TiO₂ in a range from about 4 wt. % to about 11 wt. %, the glass body comprising at least a first region and a second region; and
directing a pulsed laser beam to at least one of the first region or the second region to modify at least one of a first CTE of the first region or a second CTE of the second region.

2. The method of claim 1, wherein, prior to the directing, the first CTE is different from the second CTE.

3. The method of claim 2, wherein, if the first CTE is less than the second CTE, the directing comprises directing the pulsed laser beam at the first region of the glass body to increase the first CTE.

4. The method of claim 2, wherein, if the first CTE is greater than the second CTE, the directing comprises directing the laser beam at the second region of the glass body to increase the second CTE.

5. The method of claim 1, wherein the method further comprises forming the glass body and performing a first anneal of the glass body.

6. The method of claim 5, further comprising performing a second anneal of the glass body after the first anneal.

7. The method of claim 6, wherein the second anneal is performed prior to the directing the pulsed laser beam.

8. The method of claim 6, wherein the second anneal is performed after the directing the pulsed laser beam.

9. The method of claim 1, wherein an average hydroxyl concentration in the glass body is in a range from about 400 ppm to about 1000 ppm.

10. The method of claim 1, wherein the pulsed laser beam comprises a focus point, the method further comprising producing relative movement between the focus point and the glass body.

11. The method of claim 10, wherein the glass body comprises a glass plate comprising a first major surface, a second major surface opposite the first major surface, and a thickness defined between the first major surface and the second major surface, and the producing relative movement between the focus point and the glass body comprises varying a position of the focus point along an axis extending through the thickness of the glass body.

12. The method of claim 10, wherein the glass body comprises a glass plate comprising a first major surface, a second major surface opposite the first major surface, and the producing relative movement between the focus point and the glass body comprises varying a position of the focus point in a plane extending between the first major surface or the second major surface.

13. The method of claim 1, wherein a pulse repetition rate of the pulsed laser beam is in a range from about 100 kHz to about 1 GHz.

14. The method of claim 1, wherein an energy density of the pulsed laser beam is in a range from about 0.1 J/mm³ to about 50 J/mm³.

15. The method of claim 1, wherein a wavelength of the pulsed laser beam is in a range from about 780 nm to about 1100 nm.

16. The method of claim 15, wherein the wavelength is in a range from about 1000 nm to about 1100 nm.

17. The method of claim 1, wherein the modifying the first CTE relative to the second CTE produces a CTE gradient in the glass body.

18. A method of modifying a coefficient of thermal expansion (CTE) of an ultra-low expansion glass, comprising:
determining a spatial CTE distribution of a glass body comprising SiO₂ in a range from about 80 wt. % to about 99 wt. % and TiO₂ in a range from about 4 wt. % to about 11 wt. %, the glass body comprising at least a first region having a first CTE and a second region having a second CTE different from the first CTE; and
directing a pulsed laser beam to at least one of the first region or the second region to modify at least one of the first CTE or the second CTE; and
annealing the glass body after the directing the pulsed laser beam.

19. The method of claim 18, further comprising producing relative movement between the laser beam and the glass body such that the laser beam traverses a surface of the glass body.

20. The method of claim 18, wherein the laser beam comprises a focus point, the method further comprising varying a position of the focus point within the glass body relative to a surface of the glass body.

21. The method of claim 18, wherein a pulse repetition rate of the pulsed laser beam is in a range from about 100 kHz to about 1 GHz.

22. The method of claim 18, wherein an energy density of the pulsed laser beam is in a range from about 0.1 J/mm³ to about 50 J/mm³.

23. The method of claim 18, wherein a wavelength of the laser beam is in a range from about 780 nm to about 1100 nm.

24. The method of claim 23, wherein the wavelength is in a range from about 1000 nm to about 1100 nm.

25. The method of claim 18, wherein the modifying at least one of the first CTE or second CTE comprises increasing the at least one of the first CTE or the second CTE.

26. A method of modifying a coefficient of thermal expansion (CTE) of an ultra-low expansion glass body, comprising:
determining a spatial CTE distribution of a glass body comprising SiO₂ in a range from about 80 wt. % to about 99 wt. % and TiO₂ in a range from about 4 wt. % to about 11 wt. %, the glass body comprising at least a first region having a first CTE and a second region having a second CTE less than the first CTE; and
directing a pulsed laser beam to the second CTE to increase the second CTE.

27. The method of claim 26, further comprising annealing the glass body after the directing the pulsed laser beam, the annealing reducing an average CTE of the glass body.

28. The method of claim 26, wherein the laser beam comprises a focus point, the method further comprising varying a position of the focus point within the glass body relative to a surface of the glass body.

29. The method of claim 26, wherein a pulse repetition rate of the pulsed laser beam is in a range from about 100 kHz to about 1 GHz.

30. The method of claim 26, wherein an energy density of the pulsed laser beam is in a range from about 0.1 J/mm³ to about 50 J/mm³.

31. The method of claim 26, wherein a wavelength of the pulsed laser beam is in a range from about 780 nm to about 1100 nm.

32. The method of claim 31, wherein the wavelength is in a range from about 1000 nm to about 1100 nm.
